(19) United States
(12) Patent Application Publication
(10) Pub. No.: US 2004/0249836 A1
(43) Pub. Date: Dec. 9, 2004

(54) Synchronized data-centric and document-centric knowledge management system for drug discovery and development

(76) Inventors: John Reynders, Gaithersburg, MD (US); Scott Henderson, Chevy Chase, MD (US)

Correspondence Address: HARNESS, DICKEY & PIERCE, P.L.C., P.O. BOX 828, BLOOMFIELD HILLS, MI, 48303, US

(21) Appl. No.: 10/626,470

(22) Filed: Jul. 24, 2003

Related U.S. Application Data
(60) Provisional application No. 60/456,984, filed on Mar. 24, 2003.

(51) Int. Cl. G06F 17/30; G06F 12/00; G06F 17/00; G06F 7/00; G06N 5/02

(52) U.S. Cl. 707/100; 707/201; 706/50; 715/500

(57) ABSTRACT

The system maintains both a document-centric and a data-centric representation of data gathered during the ingest stage. Data ingest may be by internal instrument data capture, external data capture and/or manual data capture. Data is managed in a query-able form; communication among data processing modules is effected using XML. The system allows data to be cast to and from a variety of different domain-specific representations, for consumption by a variety of different domain-specific analysis stages.

### CROSS-REFERENCE TO RELATED APPLICATIONS

The present invention claims the benefit of U.S. Provisional patent application, Ser. No. 60/456,984, filed Mar. 24, 2003, the disclosure of which is hereby incorporated by reference.

### BACKGROUND OF THE INVENTION

The present invention relates generally to knowledge management systems. More particularly, the invention relates to a knowledge management system that employs a synchronized data-centric and document-centric model for representing, managing, processing and presenting information. The invention finds particular utility in managing and presenting information required to meet FDA guidelines for drug discovery, development and approval.

There are a number of industries today that must meet complex regulatory standards. Often a very significant and complex body of documentation must be assembled before a regulated product can be marketed. For example, 21 CFR part 11 specifies an extensive number of documentary steps that are required before a product can be marketed in FDA-regulated industries, such as bio-pharmaceutical (human and veterinary, personal care products, medical devices, or food and beverage). In the case of FDA compliance, the regulations mandate not only the types of data required to support an application but also the format it is expected to be in. The regulations also spell out the methods for handling the data in order to ensure that it has not become contaminated or changed in any way. The amount of supporting documentation is voluminous and diverse. Efficient methods of organizing the data while maintaining compliance with federal regulations is a challenge.

As an example, data can be generated from a plurality of laboratory instruments. Such instruments may include, DNA sequencers, gene expression analyzers, mass spectrometers, liquid chromatographs, cellular detection systems, and the like. In addition to these instruments, data can also be generated by observations and measurements performed by laboratory personnel. Examples include animal weight measurement data, behavioral change data, and the like. In addition to these sources, data and reports from outside agencies may also need to be elected and assimilated.

In many cases, it may be necessary to know the conditions under which the data was generated. This may require retention of information such as the operator that generated the data, the date the data was generated, the exact types of analysis performed on the data, who reviewed the data, and so forth. It will be appreciated that these requirements make the data collection and reporting process very complex.

Adding further to the complexity, data can have several different end destinations. In the case of a drug submission, the results may need to follow strict format requirements that are dictated by an outside agency. In the case of research and development analysis, additional date of use, reports and associations between different sets of data may be required for planning experiments in comparing results of one study to another. In the case of analyzing the success of an investigation from a business perspective, the data may be required in yet another form, in order to facilitate a go/no-go decision. Thus with many different potential destinations for the data, the extensive amount of paperwork is multiplied.

The conventional solution to the above data management problem has been to employ a document management system. Document management systems are popular information management tools in many document-intensive business applications. Unfortunately, such systems do not work well in regulatory applications of the type described above. This is in part because conventional document management systems are strongly document-centric. They do not provide the ability to combine documents or easily traverse to the original data that was used in their generation. Moreover, such conventional document management systems do not provide the ability to redesign the documents so that their contents can be cast into one or more audience-specific formats.

What is needed, therefore, is an end-to-end knowledge and information management system that can be used in complex knowledge management applications such as drug discovery, development and regulatory approval applications. The present invention provides such a solution by implementing a synchronized data-centric and document-centric knowledge management system. Among the functions performed are observation integration, data interpretation, external data integration, review and auditing, internal report generation and external report generation (including electronic submission in accordance with regulatory guidelines such as FDA guidelines).

### SUMMARY OF THE INVENTION

The knowledge management system employs an architecture that maintains a synchronized data-centric representation and a document-centric representation of data ingested into the system. According to one aspect, the knowledge management system provides a method for managing documents used in the drug discovery process in which data is received from a plurality of sources. A method to verify the integrity of the data is also obtained. The received data is converted to a common format and inputted to a workflow engine from which one or more outputs are received.

The knowledge management system employs a data structure stored in a computer-readable memory or embodied in a carrier wave comprising a data object having the following attributes associated therewith:

(a) at least one workflow attribute;

(b) at least one composition attribute;

(c) at least one audit/version control attribute:

(d) at least one compliance attribute.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a data flow diagram illustrating a knowledge management system having data-centric and document-centric capabilities;

FIG. 2 is a data structure diagram illustrating a data object and it's associated attributes;

FIG. 3 is a system diagram illustrating a conventional document management system, useful in understanding some of the limitations of prior art systems;

FIG. 4 is a system diagram illustrating how data from a laboratory instrument flows through the respective analysis, summary analysis and document creation steps under different user-defined workflow paths;

FIG. 5 is an information flow diagram illustrating different types of reports that may be generated according to different workflows;

FIG. 6 is a report diagram illustrating how different reports may be generated using the data-centric and document-centric knowledge management system;

FIG. 7 is a diagrammatic view of the dashboard functionality provided by the data-centric and document-centric knowledge management system;

FIG. 8 is a data structure diagram illustrating an object-oriented entity for use with the knowledge management system;

FIG. 9 is a entity diagram illustrating how synchronization may be performed using an example of document generation;

FIG. 10 is a data fusion framework diagram, illustrating examples of different data types that may be stored in the object-oriented entity of FIG. 8.

### DETAILED DESCRIPTION OF THE PREFERRED EMBODIMENTS

The following description of the preferred embodiment(s) is merely exemplary in nature and is in no way intended to limit the invention, its application, or uses.

The synchronized data-centric and document-centric knowledge management system deals with data in three data stages: data ingest, data management, and reporting. The data ingest stage is subdivided further into three subcategories: internal instrument data capture, external data capture and manual data capture. It is primarily in the data management stage where the data-centric and document-centric representations are synchronized. In the data management stage, all data is maintained in a query-able form enabling any desired degree of analysis to be performed. Data may be cast or to and from domain-specific representations for domain-specific analysis. The reporting stage allows the data to be used for multiple roles, for multiple purposes and at multiple analysis locales.

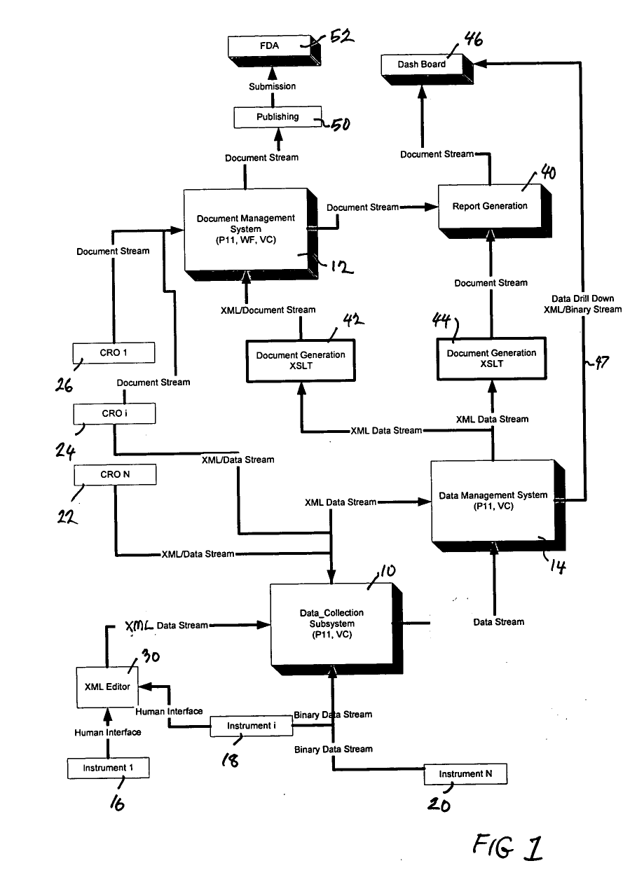

Referring to FIG. 1, an overview of the data-centric and document-centric knowledge management system will be presented through a data flow diagram. The system includes a data collection subsystem 10, a document management system 12 and a data management system 14. In the diagram of FIG. 1, the interconnecting lines represent data paths, with the arrowheads indicating the direction of data flow. The systems and subsystems communicate with each other over these data paths. Although the primary direction of data flow has been illustrated by the arrows, it will be understood that requests for data, control instructions and other messages may be passed between systems and subsystems in directions that are counter to the arrows illustrated. For example, data management system 14 may communicate with data collection subsystem 10 over the data paths indicated to request information from the data collection subsystem.

In general, data is supplied to the knowledge management system in one of three forms: raw data, analyzed data, and observation data or annotated data. Data communication is preferably effected using XML encoding, allowing the raw data and it's associated data structure to be communicated among systems and subsystems as data objects. Typically, raw data is developed using laboratory instruments such as instruments 16, 18 and 20 in FIG. 1. The raw data may, in turn, be processed using suitable data processing techniques, such as bioinformatics processing techniques, to generate analyzed data. Sources of such analyzed data might comprise one or more contract research organizations (CRO), such as those indicated at 22 and 24.

Observation data may also be supplied by entities such as contract research organizations, and frequently such data may be in a form that is not readily represented in an XML format. For illustration purposes, contract research organization 26 may be considered a source of observation data in a form that is not represented as XML data. The contract research organization 26 may supply documents containing text and graphical images, for example, which have no associated data structure. Thus, while these documents may be processed by a document management system and printed, they do not inherently carry an associated data structure or schema by which the underlying data expressed in the document can be utilized at the datalogical level. For illustration purposes, contract research organization 24 is also shown as supplying a document stream of such unstructured data to document management system 12.

With reference to the data collection subsystem 10, FIG. 1 illustrates that it is designed to receive data streams in a variety of formats, including a binary data stream and also an XML data stream. For example, instrument 20 supplies a binary data stream directly to the data collection subsystem 10. Conversely, instruments 16 and 18 communicate with data collection subsystem 10 through an intermediary XML editor 30. As illustrated, a human interface may be provided to allow the instrument operator, or other data worker, to annotate the data flowing from instruments 16 and 18 to add the appropriate XML tags.

The data collection subsystem 10 supplies a binary data stream to the data management system 14. The data management system 14 also receives an XML data stream from the contract research organizations 22 and 24, as illustrated. This system, in turn, provides data to both the document management system 12 and a report generation module 40. As illustrated, the data management system 14 supplies XML data streams to both document management system 12 and report generation 40 through a suitable document generation translation module (42 and 44) that apply the appropriate style sheets to render the respective data suitable for the document management system 12 or report generation module 40.

The report generation module 40 includes a dashboard display interface 46 that allows the user to ascertain at a glance whether there are any system delays or data hotspots that need to be specially managed. Further details of this dashboard interface will be described in connection with FIG. 7 below.

The document management system 12 can be seen in FIG. 1 as one component in the entire knowledge management process, functioning primarily as the system used to publish final documents through a suitable publishing interface 50 to the regulatory agency (in this case the FDA agency) 52. The publishing interface can be configured to supply the final submission in electronic form to agency 52.

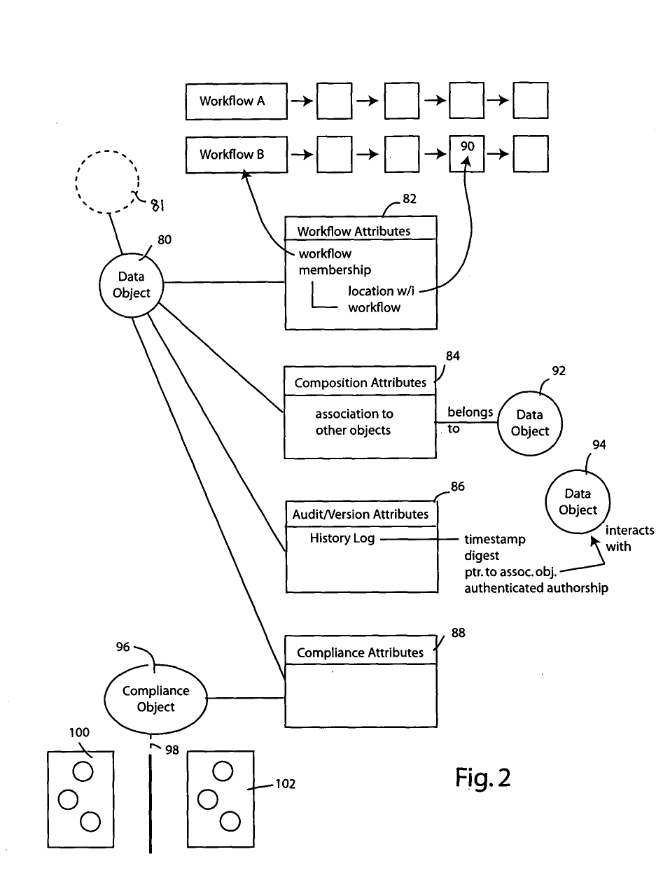

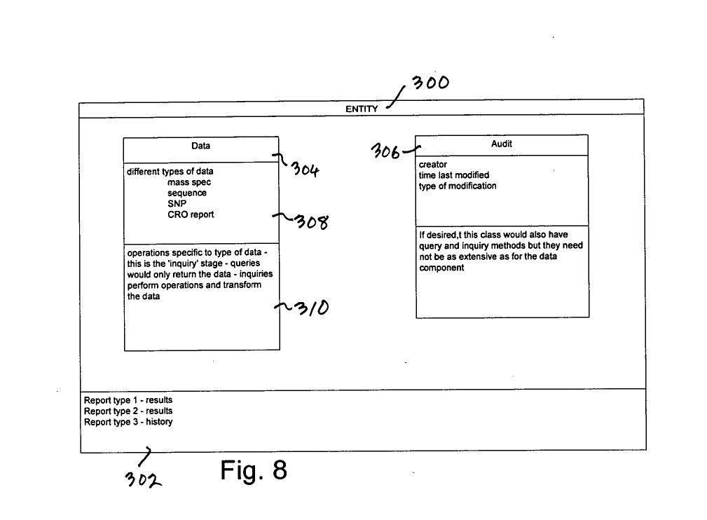

Referring now to FIG. 2, the details of the data object utilized by the knowledge management system will now be described. The data object may be implemented in computer-readable memory, or embodied in a suitable carrier wave to allow it to be communicated over a communication channel or network, such as the internet. It was previously noted that data flows through the knowledge management system in three stages: data ingest, data management and reporting. Data and document objects flowing in each of these three stages are assigned four types of attributes that are shown in FIG. 2. More specifically, FIG. 2 illustrates data object 80 and it's associated attributes: workflow attributes 82, composition attributes 84, audit/version control attributes 86 and compliance attributes 88. The data object 80 is associated with an information bearing entity, shown in dotted lines at 81. Together the data object 80 and its associated information bearing component comprise an information entity that may be expressed using an object-oriented approach, illustrated in FIG. 8 and described more fully below. Before discussing the information entity, a further discussion of data object 80 will be presented. As will be seen, the data object captures the metadata associated with the information stored in the information bearing entity 81.

In general, a data object may belong to 0,1 or many workflows. Two workflows, Workflow A, and Workflow B have been illustrated in FIG. 2. The workflow attributes associated with the data object identify both workflow membership and also location within the workflow. In FIG. 2, data object 80 is associated with Workflow B and the present instantiation of data object 80 corresponds to step 90 within the Workflow B process. As will be explained in connection with the audit/version history attributes 86, data objects may be operated upon, and hence undergo change, at various points throughout a workflow process. The system keeps a complete record of all changes, in effect, storing data about a data object at different points in time. Each point in time may correspond to a different location within the workflow. Thus the workflow location pointer may move from workflow step to step as data processing proceeds. FIG. 2 illustrates a single snapshot in time, during which data object 80 is associated with step 90 in the Workflow B process.

Data objects can be aggregated in a self-similar form. Thus data object 80 can be associated to other objects. In FIG. 2, data object 80 is nested within or belongs to data object 92. The composition attribute maintains a record when in the entity (data or document) is incorporated directly or indirectly into a new entity. This incorporation may occur recursively, to produce compositions of compositions. The system tracks and can report the composition of any entity in the system.

The audit and version control attributes maintain a detail of the history of the data object from inception through all modifications, including composition. This history may be stored in a history log that includes timestamp information, and independently maintained digest, pointers to any associated objects and authenticated authorship indicia. The time stamp information allows the life of a data object to be tracked from inception through all modifications. The independently maintained digest is constructed in such a fashion that it will demonstrate non-mutability. If a data object is inadvertently or purposely tampered with, the independently maintained digest will not longer match that of the data object and this mismatch can be used to identify such mutation. Conversely, when the maintained digest matches that of the data object, non-mutability may be demonstrated. This is an important aspect as non-mutability is required in many regulatory procedures.

Whereas, the composition attributes 84 identify other objects to which the data object belongs, the pointer to associated objects maintained in the audit/version control attributes structure identifies other objects with which the data object interacts. In FIG. 2, data object 80 interacts with data object 94. Such interaction can be present even though the two interacting data objects are not otherwise associated with each other to form a composition.

The compliance attributes 88 serve to represent how well the data object is, or is not, in compliance with a constellation of requirements. Typically these requirements are dictated by the regulatory agency, and can include workflow specification requirements, auditing requirements, version control requirement, and the like. The compliance attributes 88 points to a compliance object or set of compliance objects that in turn provide a template or baseline against which the data object may be compared. In FIG. 2, compliance object 96 has been illustrated. The compliance object or compliance template may be configured as a framework that specifies the requires schema that the data object 80 must conform to. By way of example, the framework might include a schema consisting of patient record, proofread by and signed by fields. In order for the data object to be in compliance with this framework, it should also have a patient record, proofread by and sign by fields. The compliance object thus may be viewed as a virtual mirror 98 onto which the schema of the actual data object is projected. If the schema of the data object, illustrated at 100, matches the schema of the compliance object framework, illustrated at 102, then the data object may be found to be in compliance. In a typical embodiment, there may be numerous compliance objects, each specifying different workflow, audit and version control requirements.

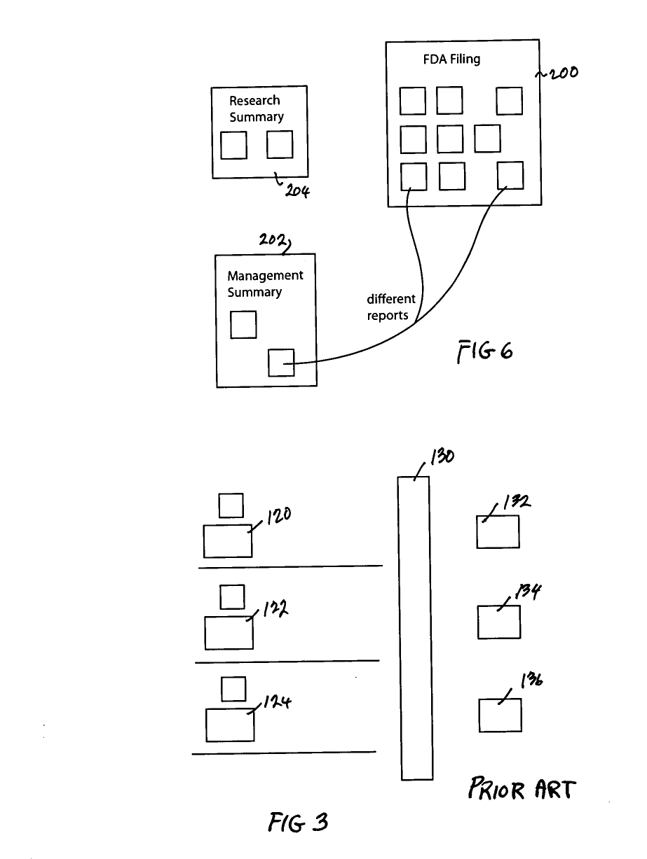

To better understand the knowledge management system in operation, it may be helpful to first review how a conventional document management system operates. Such a conventional system is shown in FIG. 3. In FIG. 3 a series of isolated laboratory instruments 120, 122 and 124 supply data to the document management system 130. Each of these instruments provides documents 132, 134 and 136, respectively. These documents are static documents. The user cannot see “inside” these documents to discover the underlying data, because the act of generating the documents has discarded the underlying data. By way of illustration, instrument 120 may be configured to collect data over a five-day interval and provide a document report that lists the average readings for each day on an hour-by-hour basis. In fact, instrument 120 may actually be capturing data at the rate of one data point every 30 seconds. By virtue of the averaging process used to generate the report, the individual data points acquired by instrument 120 are discarded when the report is generated. Thus by simply examining the static document maintained in document management system 130, it is no longer possible to ascertain what the individual data point values were. Similarly, it is not possible to ascertain other information about the instrument, such as instrument operating conditions and particular instrument settings, unless these are expressed in the document report.

The document management system 130 is, by it's very nature, a document-centric information system. It is not a data-centric information system and cannot recast data into another form. The document management system 130 is primarily designed to help a user locate the static documents for subsequent use, however, it is not designed to extract data from those documents and manipulate it to generate different view of the data suitable for consumption by different audiences.

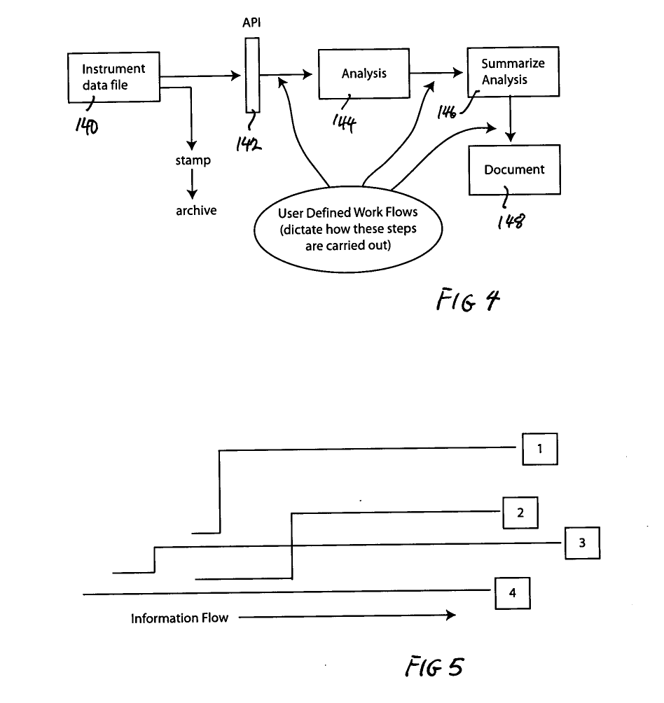

In the preceding example, instrument 120 was described in simplistic terms to make the point that data that is not captured in the static report is thus not available for subsequent use. In fact, the problem is more complex than this. As shown in FIG. 4, data from an instrument (or from some other source) will typically undergo a number of different processing and analyzing steps, often following different user-defined workflows. As shown in FIG. 4, an instrument data file 140 may be submitted through a suitable application program interface 142 to an analysis module 144 and thereafter to a summarizing module 146 and finally to a document creation module 148. The flow from module to module may be dictated by user-defined workflows that will dictate how the steps are carried out in a particular case. The knowledge management system of the invention uses the data structures and data flow systems described in FIGS. 1 and 2 to pass information from module to module in a way that the underlying data is not discarded. This is accomplished by representing data as data objects (illustrated in FIG. 2) that have all necessary attributes to allow the data management system 14 (FIG. 1) and document management 12 (FIG. 1) to generate a variety of different types of reports, based on different workflows, all without losing information about the context under which the original data was generated and subsequently manipulated. Thus, as illustrated in FIG. 4, instrument data within data file 140 is captured, time stamped and archived as a read-only document. This document may be encoded in a proprietary format, if desired, to supply assurance of non-mutability. The data is also transmitted through the application program interface 142 in an XML intermediate format for ingest into the data system. Manually entered data (such as laboratory observations and user annotations associated with raw data or analysis data) are collected through suitable interfaces, such a web interfaces or client-server tools. Once collected, these data may be converted into XML documents that are also time stamped and archived in read-only form, as well as ingested directly into the data system. Data captured from external sources which cannot be treated as manually entered data and which may not necessarily be representable in an XML format, are captured, time stamped and archived by the document management system 12 (FIG. 1). In each case, the underlying technology for ingest and management of ingested data may be based on web services or other suitable client server technology. If desired, summary information from ingested data may be made available online to support research and retrieval from the archive. Ingested data is automatically routed to the appropriate expert for interpretation.

By virtue of the synchronized data-centric and document-centric representation of all ingested data, the knowledge management system maintains all data in a form that allows queries to be conducted at any level or degree throughout the analysis. Moreover, the data is able to be cast to and from different domain-specific representations, as needed. For example, a SMILE string may be captured and represented as XML data and this string may in turn be used for chemistry-specific applications and tools. Likewise, an internal data set and a document captured from an external source can be represented in the XML format as a single, cohesive entity and then cast into a human-readable document for internal or external review. In this way, the knowledge management system maintains the advantage of being able to query and examine raw data where it is available while concurrently maintaining the ability to represent all information in the system (data and documents) in a consistent document-centric view.

One important advantage of the knowledge management system is that the ingested data can serve multiple roles and can be distributed to multiple locals for analysis. As illustrated in FIG. 5, multiple different types of reports can be generated at different stages within the information workflow (four reports are diagrammatically illustrated here). By allowing data to be associated with multiple roles, specific access can be granted to users, depending on their organization role (manager, scientist, external party). The knowledge management system takes advantage of both the flexibility of the XML format, the data object data structure (FIG. 2) and the overall data flow of the system (FIG. 1) to represent information in a manner that is tuned to each user's frame of reference. A biologist will see data in a biology-centric view; a chemist will see data in a chemistry-centric view.

The knowledge management system is capable of compiling and publishing all data into a single document, if desired. It can also provide integrated reports and submissions to external parties. Such external reporting may be implemented through internet web or forum-based interfaces using suitable web services or other client server technology. In this way, both data ingest and data reporting may be mediated by web services or client server systems to allow round-trip data analysis.

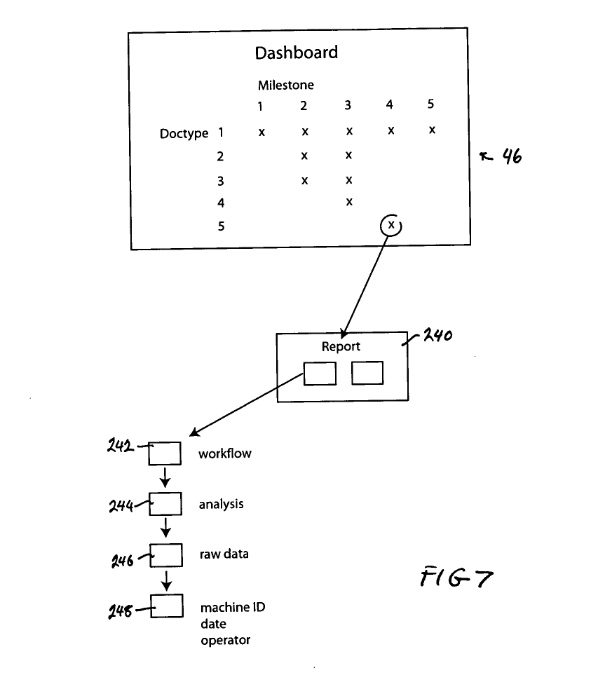

FIG. 6 illustrates how a single composite document, such as an FDA filing document 200 may be composed of many individual reports, that are in turn also capable of being reflected in other types of reports such as a management summary report 202 or a research summary report 204. As illustrated, a single report within one reporting framework (e.g., management summary 202) can be reflected in different ways in another report (e.g., FDA filing report 200).

It will be appreciated that the knowledge management system is able to mediate the development of extremely complex documents, based on many workflows which in turn may have numerous analysis steps, raw data acquisition steps and individual laboratory instrument operation parameters. It would be quite daunting to administer such a system were it not for the dashboard module shown in FIG. 1 and illustrated in greater detail in FIG. 7. Referring to FIG. 7, the dashboard 46 provides a high level view of the data flow hotspots or process hotspots that the knowledge worker may need to monitor. A variety of different user interfaces are possible. In one implementation a graphical view or grid may be provided, using different colors, such as red, yellow, green, to identify different datalogical states. The dashboard may be configured to identify a set of milestones within the overall process and a set of document types that need to be generated as the milestones are reached. The dashboard shows where a particular process may have broken down. By clicking on or drilling down into the identified trouble spot, the knowledge worker can view a particular report, such as report 240 that is associated with the trouble spot. By further drilldown, the knowledge worker can examine the individual workflow 242, analysis operation 244, raw data 246 and even the machine data 248 associated with the identified trouble spot. This allows the knowledge worker to view the entire process on the dashboard and then drill down into any trouble spots to identify exactly where the problem lies.

The powerful functionality provided by dashboard 56 is made possible by the data-centric and document-centric synchronization of the knowledge management system. By virtue of the data flow integration illustrated in FIG. 1 and the data structure illustrated in FIG. 2, the knowledge management system is able to reconstruct, on the fly, any view of the data that the knowledge worker needs to see in order to understand why a particular trouble spot has occurred. Referring to FIG. 1, it can be seen that dashboard 46 receives a document stream data flow from the report generation module 40. This data flow provides the basic dashboard view whereby milestones and document types are identified and any hotspots are flagged. When the user clicks on one of the hotspots to drill down into the associated data that lies beneath, a data flow is provided from the data management system 14 to the dashboard interface 46 via the data flow path depicted at 47 in FIG. 1.

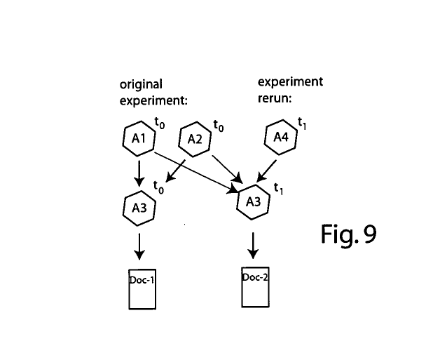

The data-centric and document-centric synchronization capability may be further understood with reference to FIGS. 8 and 9. FIG. 8 illustrates an exemplary object-oriented entity used to store information and metadata within the system. FIG. 9 gives an example of the object-oriented entity in use, illustrating how different documents may be generated, based on synchronized entities that are created at different times. While a document generation example is illustrated in FIG. 9 (to provide a document-centric view of the entity), it will be understood that information inquiries may also be submitted to the entities, to obtain a data-centric view of the entity.

The entity 300 may be implemented as a super class that encapsulates all the data and the compliance/audit information. Different reports can be produced from the entity. The report types are stored as methods 302 in the Entity class itself. The attributes of the Entity include the data 304 and the audit information 306.

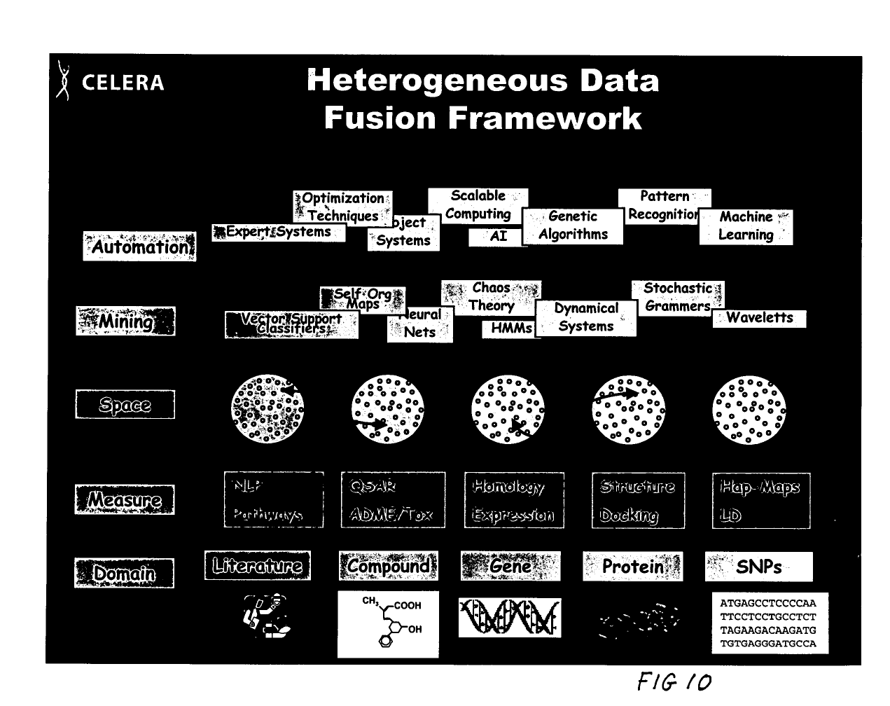

Data information 304, also referred to as data class 304, can comprise a plurality of different data types 308. Methods 310 corresponding to the different data types 308 are stored in the Data class 304. Some methods may be appropriate for all data types; whereas other methods may be appropriate for only some data types and inappropriate for others. For example, if the data type is a simple Clinical Research Organization report, it might be inappropriate to perform a ‘putative post-translational modification’ inquiry, as might be done for mass spec data. To illustrate some of the possible different data types that may be stored in the entity 300, see FIG. 10. Those skilled in the art will appreciate that these different data types may require different data inquiry methods in order to extract a relevant subset of data for further analysis and study.

The presently preferred entity 300 enables the system to make a distinction between query operations and inquiry operations. In a standard database, a query operation, as through an SQL command, can retrieve raw data from a database. However, such a query operation cannot perform a higher level scientific inquiry operation, such as performing a BLAST search upon a particular gene. To perform such a higher level inquiry, the system uses the methods stored in the entity that correspond to the particular data item in question. These methods may be stored as standard inquiries for use with a particular data type. Results of standard inquiries could be stored within the attributes section (with the main data).

Audit information 306, also referred to as audit class 306, stores all of the history/audit/compliance data and has methods for query and inquiry.

As for the Entity's report types, stored as methods at 302, in most implementations these would likely involve method calls to both the Data and Audit classes. Of course, other method calls may also be performed.

The entity structure makes synchronization easy to implement. FIG. 9 illustrates how synchronization may be accomplished. FIG. 9, illustrates an example where an experiment is run to generate some initial data, and then the experiment is rerun to refine the data, such as to tighten the error bars. As illustrated entity A3 at time t0 is

generated using entities A1 and A2 at time t0. Thereafter, the experiment is rerun, generating entity A4 at time t1. A new Entity A3 at time t1 may then be generated using entities A1 and A2 at time t0 and entity A4 at time t0. Documents may be produced from either Entity A3 at time t0 or Entity A3 at time t1.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A method for managing information used in the drug discovery process comprising:
receiving information from a plurality of sources;
obtaining a method to verify the integrity of the information;
converting the information to a common format that maintains synchronicity between a data-centric view of said information and a document-centric view of said information;
inputting the information in said common format to a workflow engine; and
receiving one or more outputs of said workflow engine.

2. The method of claim 1 further comprising:
archiving the information with a checksum after receiving from said plurality of sources.

3. The method of claim 1 wherein said workflow engine performs the following:
receiving a workflow comprising a set of user-defined steps for processing information;
receiving a plurality of data required for executing said workflow;
generating one or move views as specified by said workflow; and
publishing said one or more views.

4. A knowledge management data structure stored in a computer-readable memory or embodied in a carrier wave comprising:
a data object having the following attributes associated therewith:
(a) at least one workflow attribute;
(b) at least one composition attribute;
(c) at least one audit/version control attribute:
(d) at least one compliance attribute.

5. The data structure of claim 4 wherein said workflow attribute associates said data object with at least one workflow.

6. The data structure of claim 4 wherein said workflow attribute associates said data object with at least one workflow and associates said data object with at least one process step within said one workflow.

7. The data structure of claim 4 wherein said composition attribute associates said data object with at least one other data object in a belongs to relationship.

8. The data structure of claim 4 wherein said audit/version attribute associates said data object to a history log.

9. The data structure of claim 8 wherein said history log includes a timestamp indicia associated with said data object.

10. The data structure of claim 8 wherein said history log includes a digest record associated with said data object.

11. The data structure of claim 8 wherein said history log includes a pointer that said data object with at least one other data object with which said data object interacts.

12. The data structure of claim 8 wherein said history log includes an authorship authentication record associated with said data object.

13. The data structure of claim 4 wherein said compliance attribute associates said data object with at least one compliance object having associated compliance requirements.

14. The data structure of claim 13 wherein said compliance object represents said compliance requirements as a predefined schema.

15. An information entity stored in a computer-readable memory or embodied in a carrier wave comprising:
a data component to store information according to at least one predetermined data type;
said data component having at least one associated method used to perform an inquiry with respect to said stored information;
an audit component to store metadata associated with said stored information; and
an entity methods component used to perform document generation using said stored information.

16. The information entity of claim 15 wherein said information data component stores a plurality of different data types and stores a plurality of different methods used to perform inquires with respect to specified data types.

17. The information entity of claim 15 wherein said associated method performs an inquiry that transforms at least a portion of said stored information according to a predetermined method.

18. The information entity of claim 15 wherein said audit component stores audit methods used to operate upon said metadata.

19. The information entity of claim 15 wherein said audit component stores metadata that describes the manner in which the stored information has been processed.

20. The information entity of claim 15 wherein said associated method of said data component functions to provide a data-centric view of said information.

21. The information entity of claim 15 wherein said entity methods component functions to provide a document-centric view of said information.
